(19) United States
(12) Patent Application Publication
(10) Pub. No.: US 2008/0165108 A1
(43) Pub. Date: Jul. 10, 2008

(54) Method for driving liquid crystal display in a multi-frame polarity inversion manner

(75) Inventors: Yuh-Ren Shen, Hsinchu (TW); Chang-Cheng Lin, Hsinchu (TW)

Correspondence Address: BACON & THOMAS, PLLC, 625 SLATERS LANE, FOURTH FLOOR, ALEXANDRIA, VA, 22314, US

(73) Assignee: VastView Technology Inc., Hsinchu (TW)

(21) Appl. No.: 11/797,525

(22) Filed: May 4, 2007

(30) Foreign Application Priority Data
Jan. 10, 2007 (TW) 096100967
Mar. 26, 2007 (TW) 096110338

(51) Int. Cl. G09G 3/36

(52) U.S. Cl. 345/94

(57) ABSTRACT

The present invention discloses a method for driving a liquid crystal display device for enhancing a picture quality. More specifically, a method for driving liquid crystal display in a multi-frame polarity inversion manner is disclosed. Based on standard liquid crystal display structure, hardware and specification, the method improves frame rate by increasing input rate of grayscale level with a better brightness performance and fewer loss of grayscale. The method comprises the following steps of: setting two or more voltage-controls during frame period of liquid crystal display panel to increase frame rate; setting a first grayscale level and a first voltage corresponding to the first grayscale level to represent brightness on liquid crystal display panel during a first voltage-control; and setting a second grayscale level and a second voltage corresponding to the second grayscale level to represent brightness on liquid crystal display panel during a second voltage-control which is just behind and in the same polarity as the first voltage-control.

### BACKGROUND OF THE INVENTION

1. Field of the Invention

The present invention relates to a method for driving liquid crystal display in a multi-frame polarity inversion manner, and more particularly for driving liquid crystal display in a multi-frame polarity inversion manner with higher frame rate and plurality of voltage-controls in the same frame period.

2. Description of the Prior Art

In recent years, the more and more advanced technology drives liquid crystal display toward a field of smaller volume and lighter weight. Liquid crystal display (LCD) is the one could be the major trend of display and can be applied on digital television, notebook, or desktop PC screen. Although LCD has many advantages, such as low power consumption, light weight, and negative screen radiation and glitter, considerable coefficients of viscosity, elasticity, dielectric and etc. still give some restrictions and disadvantages on LCD's application.

When the display rate of the picture is grater than 25 frames per second, the fast changed pictures will become continuous pictures to human eyes thus to create visual pictures including dynamic film and TV game animation. In most displays, frame rate is generally greater than 60 frames per second in order to perform a smoother motion for movies or animation, game or high quality DVD movies. To perform different brightness on LCD panel is to control voltage on LCD cell. Every cell in LCD panel is full of liquid crystal molecules whose alignment rotates with applied electric field strength. Higher applied voltage means the alignment is more parallel to plane direction of cell glass and the more light from backlight module can go through the cell. Therefore, no light from backlight module can go through the cell when applied voltage is zero. Although alignment is changed with applied voltage, it still needs response time to reach an anticipative brightness. Traditionally, an overdrive (OD) technology to increase driving voltage at changing moment can slightly diminish the response time without changing panel structure.

As shown on FIG. 8, brightness of frame N and frame N+1 are represented by target code and target voltage 61. After an OD process, only target code of frame N is replaced by an overdrive code (OD code). Therefore, voltage driven by the OD code can respond to target voltage of frame N quickly as corresponding voltage variation 62. By the symmetry of liquid crystal, brightness is decided by absolute value of voltage differential between display electrode and common electrode event though the electric polarity is opposite. Because liquid crystals remaining in a fixed alignment will suffer a problem of elastic fatigue, a driving voltage which has alternative polarity with time but keeps same absolute value of voltage differential can solve the problem. It is so-call polarity inversion manner for LCD panel. Generally, it is at state of positive polarity when display electrode voltage is greater than common electrode voltage (Vcom), and it is at state of negative polarity when display electrode voltage is less than common electrode voltage.

Traditionally, polarity of whole pixels in display is changed alternatively as frame changes. Difference between four modes of polarity inversion is polarity distribution of adjacent pixels. In Frame inversion, whole display are in the same polarity (as FIG. 9A shown). In column inversion, pixels on same column are in the same polarity and polarity of adjacent column is opposite (as FIG. 9B). In row inversion, pixels on same row are in the same polarity and polarity of adjacent row is opposite (as FIG. 9C). In dot inversion, pixel is in opposite polarity with its adjacent pixels (as FIG. 9D).

For needs of fast response speed and good image quality, a high-frame-rate display with refresh-rate modifications from standard panel structure was developed. The standard 60 Hz frame rate can be upgraded to 70 Hz, 80 Hz and even to 120 Hz in the high-frame-rate display. After changing the refresh-rate of display, charging and discharging time for cell's capacity is reduced and not enough to drive voltage to accurate brightness. FIG. 10 shows exemplary target voltage level and grayscale level variations for 120 Hz frame rate in the high-frame-rate display panel. Code 81, 81′ on FIG. 8 represent voltage range for 60 Hz. Obviously, charging and discharging time for 120 Hz is reduced as half for 60 Hz. Code 82 of original first frame of brightness changing moment for 60 Hz is divided by frame N and frame N′ for 120 Hz. For quickly reaching the target voltage level, an OD code is sent during frame N in positive polarity and a target code is sent during frame N′ in negative polarity. The corresponding voltage variations in frame N and frame N′ are shown as curve 83 and curve 84.

Although the high-frame-rate display can improve frame rate to 120 Hz by speeding up refresh-rate, but charging and discharging time for cell's capacity is also reduced as half too. OD code in frame N and target code in frame N′ really help voltage variation 83 for 120 Hz in frame N rising faster than voltage variation 85 for 60 Hz in first frame 82, but the final driving voltages in frame N and frame N′ are still not enough to drive accurate voltages 85,81′ for 60 Hz and cause loss of grayscale. The key issue for loss of grayscale is the greater voltage differential with higher frequency of polarity inversion between frame N and frame N′.

Further, a feed-through effect causes a peak 831 and a canyon 832 voltage during charging and discharging time for cell capacitance and biases average voltage above common electrode voltage Vcom in high-frame-rate display panel. After a certain period, movie flicking and image sticking appear due to the offset of driving voltage. When the response time is not really enough, users will see a half-dark display panel or darker regions along gate line on display panel.

Additionally, due to the slow response time of liquid crystal, motion blur for eye tracking will happen in a hold-type LCD display which same driving voltage is as long as frame period. In order to solve problem of motion blur, a pseudo impulse-type display from the idea of CRT monitor is used. In pseudo impulse-type LCD display, images is displayed by using black-data/black-scene insertion, or flashing backlight.

Due to the high frame rate technology, the high-frame-rate display is also used in pseudo impulse-type display. As shown on FIG. 11, black-data represented by code 0 is inserted on frame N′, N+1′, N+2′, N+3′ and so on instead of target code. Grayscale level and corresponding voltage variations are shown on curve 91 and 92 of FIG. 9. However, because charging and discharging time for cell capacitance is not enough again to respond driving voltage as well as the voltage in normal frame rate (as curve 93 shown), problems of loss of grayscale and non-uniform brightness will cause flicking and image sticking on display.

Further, in order to upgrade standard panel from 60 Hz to higher frequency display, it needs changes for hard ware structure of display such as double number of gate driver or data driver. However, double number of gate driver or data driver will push data-line or turn-on resistor to operation limits and will cost double or event more material, effort, and time during producing or design.

Thus, inventors depending on their abundant experience on LCD design and producing figure out the present invention for solving mentioned problems after many cycles of consideration, produce, and modification.

### SUMMARY OF THE INVENTION

The main object of the present invention is to provide a method for driving liquid crystal display in a multi-frame polarity inversion manner. Based on standard liquid crystal display structure, hardware and specification, the invention has the better brightness performance and fewer loss of grayscale. Due to the lower cost advantage, product competition is improved.

Further object of the invention is to provide a method for driving liquid crystal display in a multi-frame polarity inversion manner with higher input rate of grayscale level. Because there are two or more voltage-controls in same polarity frame period, voltage differential between voltage-controls is smaller than the high-frame-rate display and voltage response can quickly present the target brightness.

Further object of the invention is to provide a method for driving pseudo impulse-type display in a multi-frame polarity inversion manner. Black-data insertion in second voltage-control can diminish problems of loss of grayscale and non-uniform brightness.

In order to reach the objects, the method for driving liquid crystal display in a multi-frame polarity inversion manner according to the invention comprises the following steps: setting two or more voltage-controls during frame period of liquid crystal display panel to increase frame rate; setting a first grayscale level and a first voltage corresponding to the first grayscale level to represent brightness on liquid crystal display panel during a first voltage-control; and setting a second grayscale level and a second voltage corresponding to the second grayscale level to represent brightness on display panel during a second voltage-control which is just behind and in the same polarity as the first voltage-control. With the invention, there is no need of changes on the standard display structure and there is no need of increasing duty of power (duty-free). In addition to LCDs, the present invention could also be applied to plasma displays, organic light emitting diplays (OLEDs), or other displays with similar driving mechanism.

For a more complete understanding of the features and advantages of the present invention, reference is now made to the following description taken in conjunction with accompanying drawings.

### BRIEF DESCRIPTION OF THE DRAWINGS

FIG. 1 shows a schematic diagram of voltage variations for the first embodiment according to the present invention.

FIG. 2 shows a schematic diagram of voltage variation for the second embodiment according to the present invention.

FIG. 3 shows a schematic diagram of voltage variation for the third embodiment according to the present invention.

FIG. 4 shows a schematic diagram of voltage variation for the forth embodiment according to the present invention.

FIG. 5 shows a schematic diagram of voltage variation for the fifth embodiment according to the present invention.

FIG. 6 shows a schematic diagram of voltage variation for charging voltage compensation according to the present invention.

FIG. 7 shows a schematic diagram of compensation area for charging voltage compensation according to the present invention.

FIG. 8 illustrates a prior art to show a schematic diagram of voltage variation for driving liquid crystal display.

FIG. 9A illustrates a prior art to show a schematic diagram for frame inversion.

FIG. 9B illustrates a prior art to show a schematic diagram for column inversion.

FIG. 9C illustrates a prior art to show a schematic diagram for row inversion.

FIG. 9D illustrates a prior art to show a schematic diagram for dot inversion.

FIG. 10 illustrates a prior art to show a schematic diagram of voltage variation for high-frame-rate display.

FIG. 11 illustrates a prior art to show a schematic diagram of voltage variation for high-frame-rate display in pseudo impulse-type.

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

The present invention is based on structure of traditional display panel without hardware upgrade. In order to show image on display panel, display region is divided by plurality of tiny picture elements (pixels). By setting different brightness on pixels, an image can be shown on liquid crystal display panel. In LCD panel, pixel's brightness is decided by driving voltage on liquid crystal cell (or cells for RGB system). Generally, the driving voltage is controlled by grayscale level of pixel.

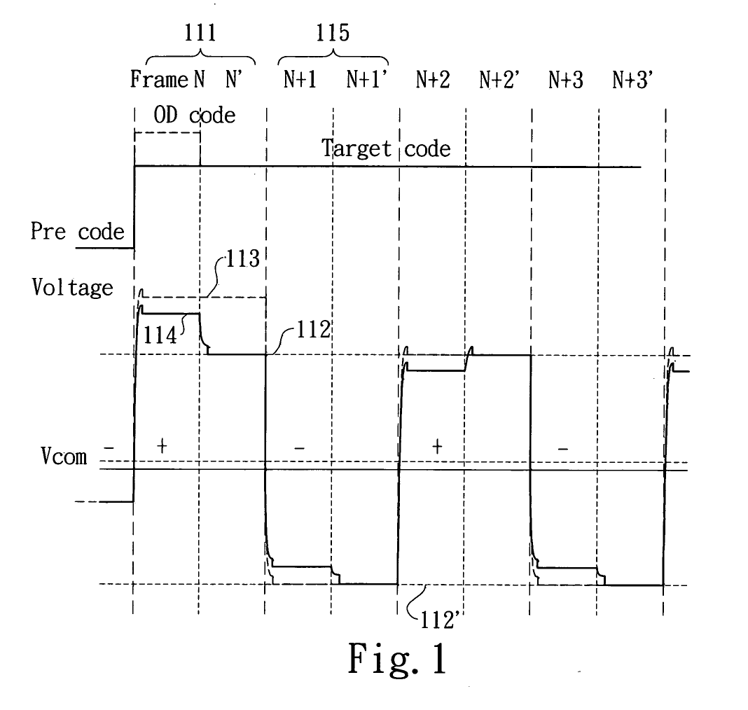

FIG. 1 is a schematic diagram showing the pixel brightness is changed and represented from pre code to target code by a first embodiment of the present invention. As illustrated, upon receiving image data within four frames, each frame corresponding to a gray scale code of the image data for the light beam to create changes in dimness through the luminance of the liquid crystal box. In the first four frame periods, frame rate is doubled and frame period is separated into two voltage-controls.

In first frame period 111, frame N and frame N′ individually represent the first voltage-control and second voltage-control and the standard frame rate is upgraded from 60 Hz to 120 Hz. Because frame N is at changing moment from pre code to target code, an OD code is set to be a first grayscale level. A first voltage corresponding to the first grayscale level can overdrive display panel. Because of large voltage differential at the changing moment, voltage variation 114 in frame N corresponding to the OD code can not perform as same as voltage variation 113 in first frame period of 60 Hz for less charging time. Nevertheless, voltage variation 114 in frame N is still higher than the voltage 112 corresponding to the target code and that is the OD code's function.

In the second voltage-control, frame N′, a second voltage with the same polarity of the first voltage (in frame N) is set by second grayscale level, the target code of first frame period 111. Because polarity of frame N and frame N′ are the same due to a polarity control, voltage differential is such small that voltage variation 114 can quickly reach the voltage 112 corresponding to the target code in frame N′ for enough discharging time. By this multi-frame polarity inversion manner, frame rate in the invention can be increased to 120 Hz but there is no need of extra duty for extra polarity inversion in the first frame period.

In the second frame period 115, although discharging time is not enough due to polarity inversion, the voltage variation in frame N+1 is not too far from the voltage 112′ corresponding to the target code in frame N+1 for the smaller voltage differential between frame N′ and frame N+1. Nevertheless, the insufficient voltage to the voltage 112′ corresponding to the target code in frame N+1 can be made up in frame N+1′ quickly for the same polarity of frame N+1 and frame N+1′. Therefore, a method according to the invention can diminish loss of grayscale which is a serious problem in traditional high-frame-rate display.

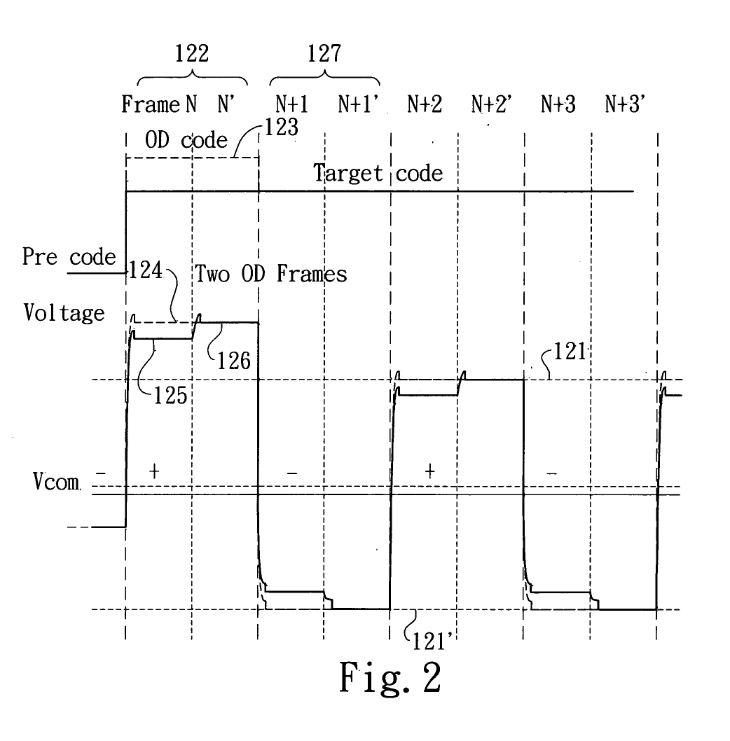

In second embodiment, pixel brightness is changed and represented from pre code to target code as shown on FIG. 2. In the first four frame periods, frame rate is doubled and frame period is separated into two voltage-controls.

In the first frame period 122, frame N and frame N′ individually represent the first voltage-control and second voltage-control and the original frame rate is upgraded from 60 Hz to 120 Hz. Because frame N is at changing moment from pre code to target code, an OD code 123 is set to be a first grayscale level. A first voltage corresponding to the first grayscale level can overdrive display panel. Because of large voltage differential at the changing moment, voltage variation 125 in frame N corresponding to the OD code 123 can not perform as same as voltage variation 124 in first frame period of 60 Hz for less charging time. Nevertheless, voltage variation-125 in frame N is still higher than the voltage 121 corresponding to the target code and that is the OD code's function.

In the second voltage-control, frame N′, a second voltage with the same polarity of the first voltage (in frame N) is set by the same OD code 123 in frame N. Because polarity of frame N and frame N′ are the same due to a polarity control, voltage variation 125 can quickly reach the voltage 121 corresponding to the OD code for enough charging time.

In the second frame period 127, although discharging time is not enough due to polarity inversion, the voltage variation in frame N+1 is not too far from the voltage 121′ corresponding to the target code in frame N+1 for the smaller voltage differential between frame N′ and frame N+1. Nevertheless, the insufficient voltage to the voltage 121′ corresponding to the target code in frame N+1 can be made up in frame N+1′ quickly for the same polarity of frame N+1 and frame N+1′. Therefore, a method according to the invention can diminish loss of grayscale which is a serious problem in traditional high-frame-rate display.

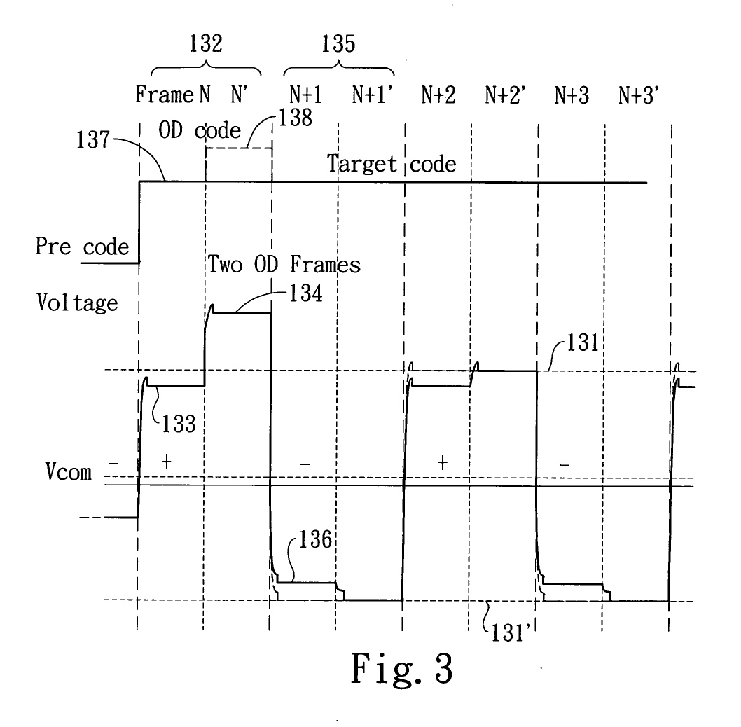

FIG. 3 is an exemplary illustration for third embodiment according the present invention. In first frame period 132, frame N and frame N′ individually represent the first voltage-control and second voltage-control and the standard frame rate is upgraded from 60 Hz to 120 Hz. In frame N (first voltage-control), a target code for first frame duration 132 is set to be a first grayscale level 137. A resulted voltage variation 133 corresponding to the first grayscale level 137 can not reach target voltage variation 131 for not enough charging time.

Further, an OD code is set to be a second grayscale level 138. The second grayscale level 138 is higher than the target code in the first frame period and can overdrive display panel. A resulted voltage variation 134 corresponding to the second grayscale level 138 is higher than the target voltage variation 131 due to the overdrive voltage in the second voltage-control which has the same polarity with the first voltage-control duration. Besides, following frame periods behind the first period 132, a second frame period 135 for example, a voltage variation 136 closer to the target voltage variation 131 can be made.

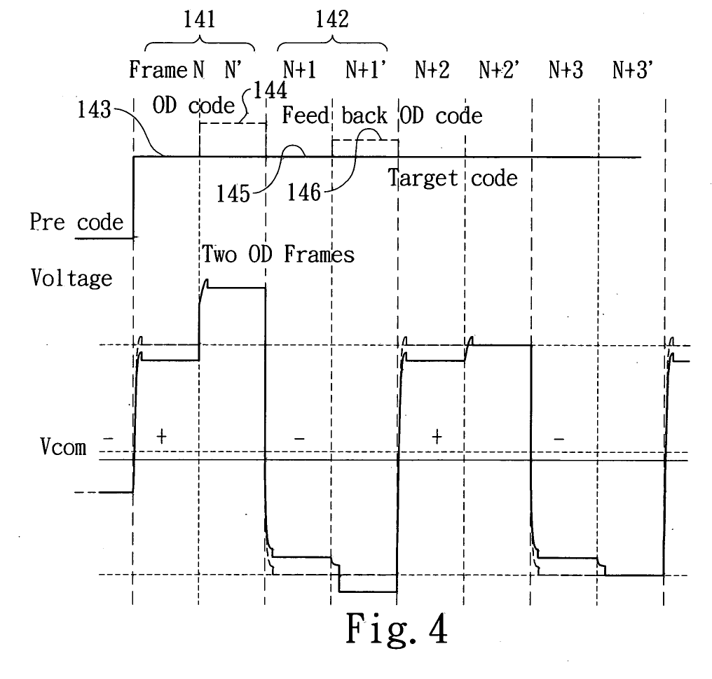

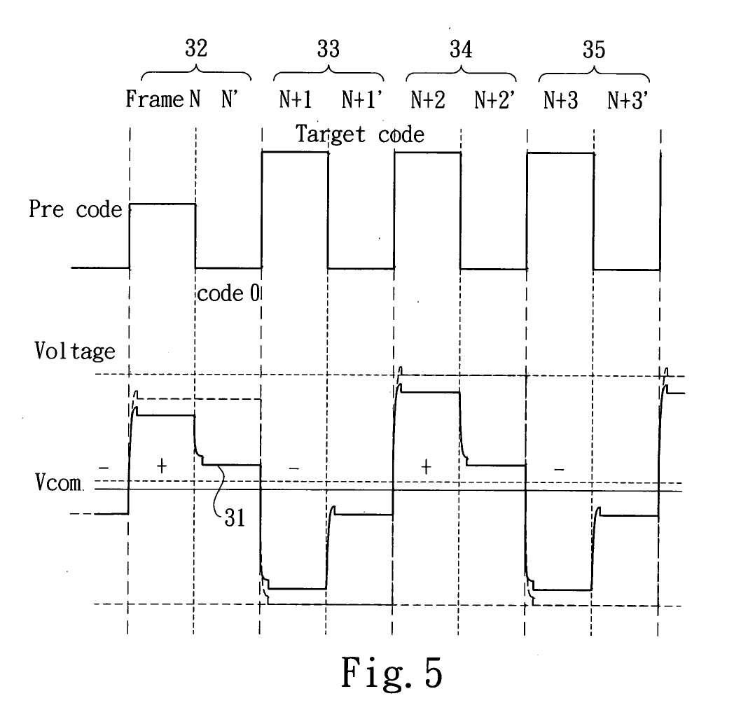

FIG. 4 is an exemplary illustration for forth embodiment according the present invention. The forth embodiment is an extended embodiment from the third embodiment. In first frame period 141, frame N and frame N′ individually represent the first voltage-control and second voltage-control and the standard frame rate is upgraded from 60 Hz to 120 Hz as well as the third embodiment. In frame N (first voltage-control), a target code for first frame duration 141 is set to be a first grayscale level 143. In frame N′ (second voltage-control), an OD code is set to be a second grayscale level 144.

In order to make up the possible not enough charging time in the first frame period 141, a second frame period 142 is divided into frame N+1 and frame N+1′ for a third voltage-control and a forth voltage-control. A third grayscale level 145 and a forth grayscale level 146 control brightness in the frame N+1 and N+1′.

The difference with the third embodiment is the third grayscale level 145 is the same as the first grayscale level 143, which is the target code in the first frame period and the forth grayscale level 146 is a feedback OD code adjusted by the OD code in the second voltage-control. In frame N+1′, display panel is overdriven again in order to result a closer voltage variation to the target voltage variation. Because display panel has been overdriven in frame N′, the forth grayscale level 146 can be less than the second grayscale level 144. Polarities for the third voltage-control and the forth voltage-control are the same but polarities in the first frame period 141 and the second frame period 142 are not opposite. Through the forth embodiment according to the present invention, the problem of not enough charging time can be improved.

Fifth embodiment according the present invention is an exemplary embodiment for pseudo impulse-type display. In fifth embodiment, pixel brightness is changed and represented from pre code to target code as shown on FIG. 3. In the first four frame periods, frame rate is doubled and frame period is separated into two voltage-controls. The first voltage-control in the four frame periods 32, 33, 34, 35 are frame N, N+1, N+2, and N+3. The second voltage-control in four frame periods 32, 33, 34, 35 are frame N′, N+1′, N+2′, and N+3′. As well as the first embodiment and second embodiment, polarity of first and second voltage-controls in same frame period are the same, input rate of grayscale level is increased to 120 Hz, and first and second grayscale levels are set to control voltage in first and second voltage-controls respectively.

The difference from the mentioned embodiments is: the second grayscale level in each second voltage-control is not target code but a code 0 for black-scene. In practical operation, to generate a black-scene is not necessary by code 0. A grayscale level near code 0 is small enough for black-scene, for example, code 5˜10. For a clear description, code 0 is represented as a grayscale level of black-data in the following description.

In frame N, N+1, N+2, and N+3, a pre code or target code are set as first grayscale level in four frame periods 32, 33, 34, 35. In frame N′, N+1′, N+2, and N+3′, a code 0 is set as second grayscale level in four frame periods 32, 33, 34, 35 and the polarity is the same as first voltage-control. In another exemplary embodiment, an OD code can be set as the first grayscale level in frame N.

Loss of grayscale could happen due to the reduced charging and discharging time in the high-frame-rate display and a display according to the invention. By increasing cell-gap of display, brightness of whole display panel can be increased too. A further embodiment of the invention can diminish the loss of grayscale and the non-uniform brightness distribution which is caused by non-uniform cell-gap distribution between center region and gate line regions at the same time. In the further embodiment, a charging voltage compensation step is to divide display panel by plurality of compensation area which has a or plurality of compensation grayscale level to record necessary compensation for local brightness differential. The compensation grayscale level can be detected by actual brightness distribution on display panel.

Because display is clamped in a hard frame, liquid crystal cell along the sides of hard frame is pressed and cell-gap in those cells becomes smaller than in center cells. Therefore, the compensation grayscale level for those cells should be greater than center cells, in order to increase extra brightness for compensation. Obviously, compensation grayscale level is stepwise distributed from center to side regions.

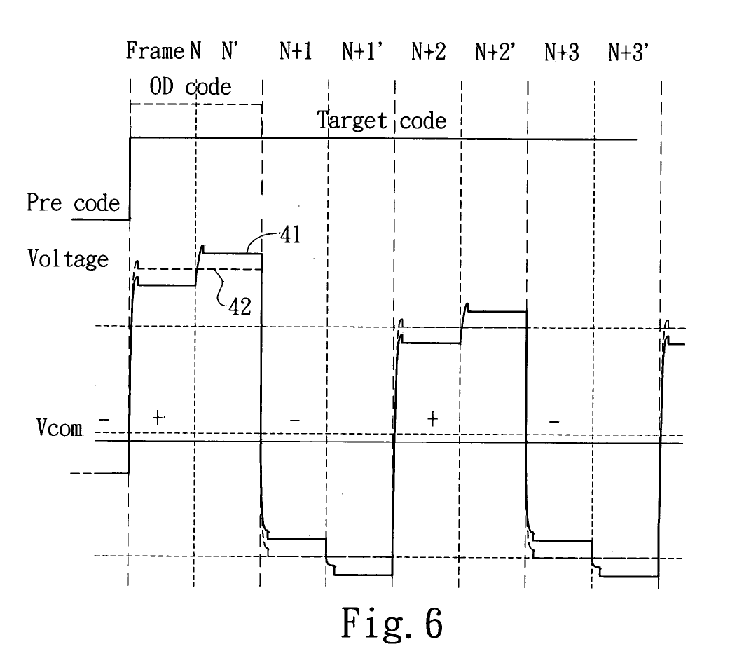

The compensation grayscale levels can be stored in look-up tables. When display is proceeding on second voltage-control according to the invention, the second grayscale level on different compensation area can be modified by those look-up tables. As shown on FIG. 6, actions in frame N′ are to take the compensation grayscale level from look-up tables and modify the second grayscale level. After charging voltage compensation, voltage variational in frame N′ is higher than voltage 42 corresponding to the target code. The loss of grayscale is therefore compensated.

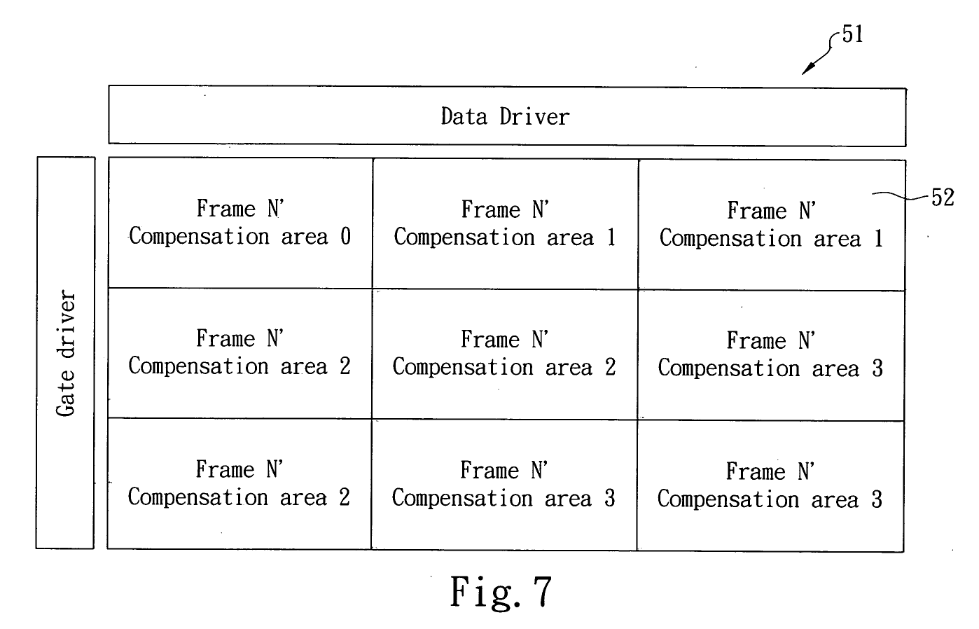

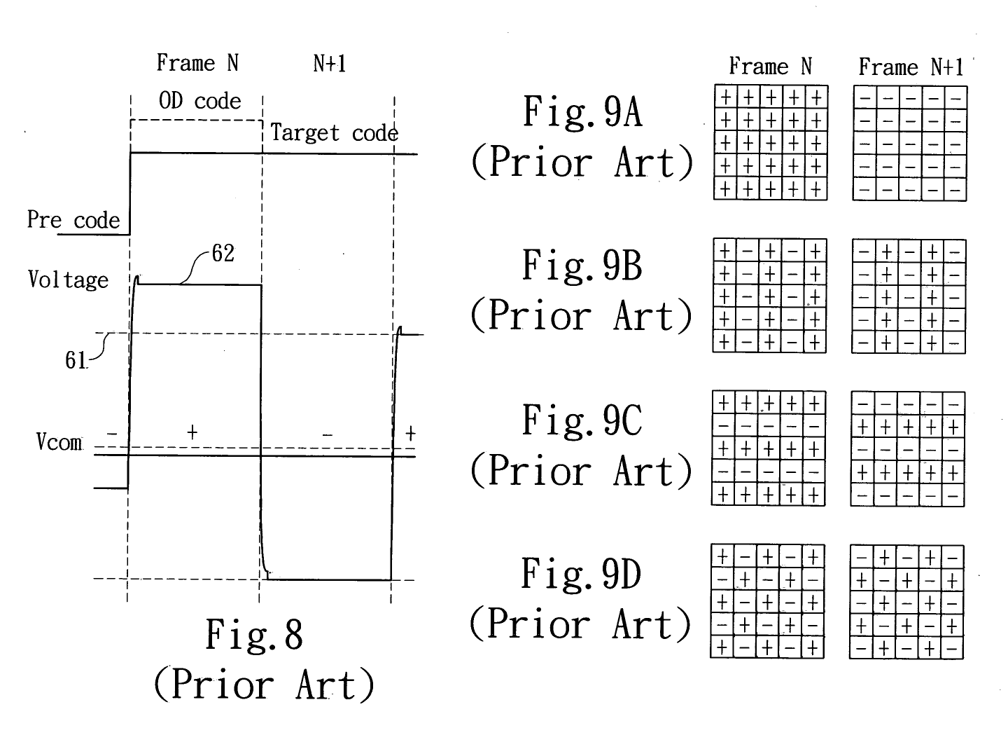

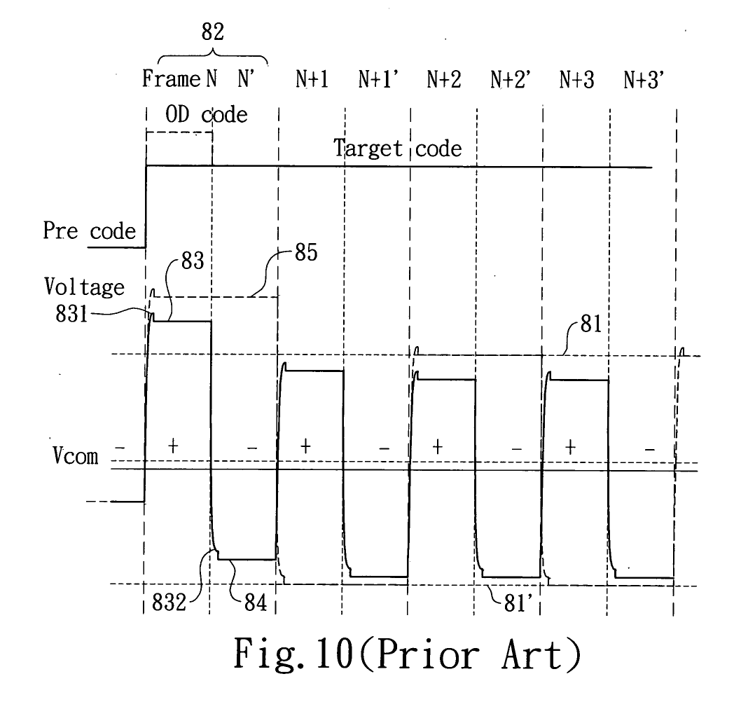

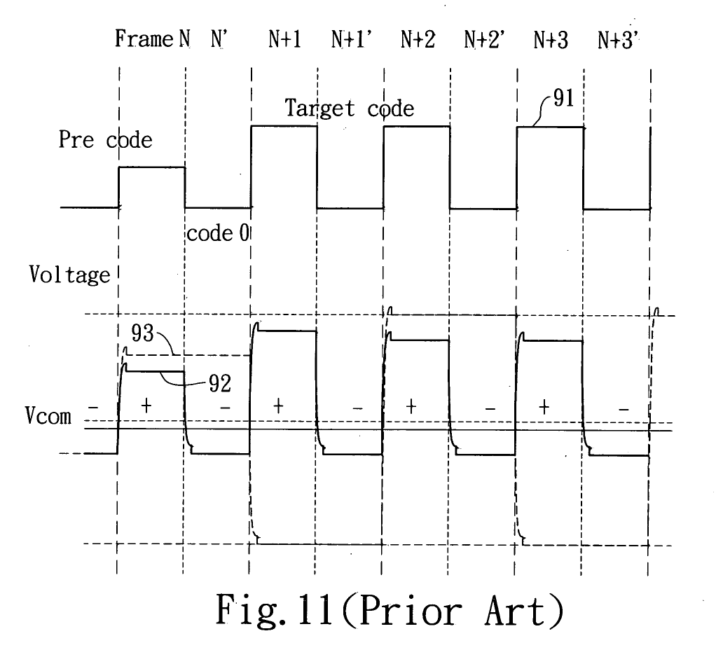

The compensation area can be divided by rectangular ranges or linear ranges. For rectangular ranges as FIG. 7, a display area 51 is divided into nine compensation area 52. In an exemplary embodiment, a smaller compensation area such as 32×32 or 64×64 pixels can be divided for getting a close image to accurate brightness.

In order to get a closer image to accurate brightness, a compensation area along gate line by linear regions with the more detailed compensation grayscale level is used.

Thereby, the present invention has the following advantages:
1. Without changing the ordinary hardware structure of display panel, the method according to this invention can diminish the loss of grayscale by less charging and discharging time and is duty-free.
2. The applied voltage manner according to this invention can reduce voltage differential at polarity inversion and quickly reach the target brightness.
3. The charging voltage compensation manner according to this invention can solve the problem of brightness non-uniform due to producing process.

Accordingly, as disclosed by the above description and accompanying drawings, the present invention surely can accomplish its objectives to provide a method for driving liquid crystal display in a multi-frame polarity inversion manner, and may be put into industrial use especially for mass product.

It should be understood that various modifications, variations, and appliance such as organic light-emitting diode (OLED) or plasma display panel (PDP) could be made from the teaching disclosed above by the person familiar in the art, without departing the spirit of the present invention

What is claimed is:

1. A method for driving liquid crystal display in a multi-frame polarity inversion manner comprises the following steps of:
setting two or more voltage-controls during frame period of liquid crystal display panel to increase frame rate;
setting a first grayscale level and a first voltage corresponding to the first grayscale level to represent brightness on liquid crystal display panel during a first voltage-control; and
setting a second grayscale level and a second voltage corresponding to the second grayscale level to represent brightness on liquid crystal display panel during a second voltage-control which is just behind and in the same polarity as the first voltage-control.

2. A method for driving liquid crystal display in a multi-frame polarity inversion manner according to claim 1, wherein the first grayscale level can overdrive liquid crystal display panel.

3. A method for driving liquid crystal display in a multi-frame polarity inversion manner according to claim 1, wherein the second voltage is a necessary voltage for reaching target code of the frame period.

4. A method for driving liquid crystal display in a multi-frame polarity inversion manner according to claim 1, wherein the second voltage is a necessary voltage for reaching overdrive code of the frame period.

5. A method for driving liquid crystal display in a multi-frame polarity inversion manner according to claim 1, wherein the second voltage is in a higher value of necessary voltage for reaching target code of the frame period.

6. A method for driving liquid crystal display in a multi-frame polarity inversion manner according to claim 1, wherein the second voltage is a necessary voltage for completing a dark scene.

7. A method for driving liquid crystal display in a multi-frame polarity inversion manner according to claim 1, further comprises a step of: setting a charging voltage compensation for brightness uniformity according to brightness distribution on liquid crystal display panel.

8. A method for driving liquid crystal display in a multi-frame polarity inversion manner according to claim 7, wherein the charging voltage compensation is to divide liquid crystal display panel by plurality of compensation area which has a or plurality of compensation grayscale level to record necessary compensation for local brightness differential.

9. A method for driving liquid crystal display in a multi-frame polarity inversion manner according to claim 8, wherein the compensation grayscale level in every compensation area are arranged as step change.

10. A method for driving liquid crystal display in a multi-frame polarity inversion manner according to claim 8, wherein the compensation grayscale level in every compensation area are stored in a or plurality of look-up tables for downloading.

11. A method for driving liquid crystal display in a multi-frame polarity inversion manner according to claim 8, wherein the compensation area are defined by rectangular ranges.

12. A method for driving liquid crystal display in a multi-frame polarity inversion manner according to claim 8, wherein the compensation area are defined by linear ranges.

13. A method for driving liquid crystal display in a multi-frame polarity inversion manner according to claim 7, wherein the compensation grayscale level are detected by actual brightness distribution on liquid crystal display panel.

14. A method for driving liquid crystal display in a multi-frame polarity inversion manner according to claim 1, wherein the liquid crystal display panel is liquid crystal display (LCD), organic light emitting diode (OLED), or plasma liquid crystal display panel (PDP).

15. A method for driving liquid crystal display in a multi-frame polarity inversion manner comprises the following steps of:
setting two or more voltage-controls during frame period of liquid crystal display panel to increase frame rate;
setting a first grayscale level and a first voltage corresponding to the first grayscale level to represent liquid crystal display panel brightness and overdrive liquid crystal display panel during a first voltage-control; and
setting a second grayscale level and a second voltage corresponding to the second grayscale level to represent brightness on liquid crystal display panel during a second voltage-control which is just behind and in the same polarity as the first voltage-control.

16. A method for driving liquid crystal display in a multi-frame polarity inversion manner according to claim 15, wherein the second voltage is a necessary voltage for reaching target code of the frame period.

17. A method for driving liquid crystal display in a multi-frame polarity inversion manner according to claim 15, wherein the second voltage is a necessary voltage for reaching overdrive code of the frame period.

18. A method for driving liquid crystal display in a multi-frame polarity inversion manner according to claim 15, wherein the second voltage is in a higher value of necessary voltage for reaching target code of the frame period.

19. A method for driving liquid crystal display in a multi-frame polarity inversion manner according to claim 15, wherein the second voltage is a necessary voltage for completing a dark scene.

20. A method for driving liquid crystal display in a multi-frame polarity inversion manner according to claim 15 further comprises a step of: setting a charging voltage compensation for brightness uniformity according to brightness distribution on liquid crystal display panel, wherein the charging voltage compensation is to divide liquid crystal display panel by plurality of compensation area which has a or plurality of compensation grayscale level to record necessary compensation for local brightness differential.

21. A method for driving liquid crystal display in a multi-frame polarity inversion manner according to claim 20, wherein the compensation grayscale level in every compensation area are arranged as step change.

22. A method for driving liquid crystal display in a multi-frame polarity inversion manner according to claim 20, wherein the compensation grayscale level in every compensation area are stored in a or plurality of look-up tables for downloading.

23. A method for driving liquid crystal display in a multi-frame polarity inversion manner according to claim 20, wherein the compensation area are defined by rectangular ranges.

24. A method for driving liquid crystal display in a multi-frame polarity inversion manner according to claim 20, wherein the compensation area are defined by linear ranges.

25. A method for driving liquid crystal display in a multi-frame polarity inversion manner according to claim 20, wherein the compensation grayscale level are detected by actual brightness distribution on liquid crystal display panel.

26. A method for driving liquid crystal display in a multi-frame polarity inversion manner according to claim 15, wherein the liquid crystal display panel is liquid crystal liquid crystal display (LCD), organic light emitting diode (OLED), or plasma liquid crystal display panel (PDP).

27. A method for driving liquid crystal display in a multi-frame polarity inversion manner comprises the following steps of:
setting two or more voltage-controls during frame period of liquid crystal display panel to increase frame rate;
setting a first grayscale level and a first voltage corresponding to the first grayscale level to represent brightness on liquid crystal display panel during a first voltage-control; and
setting a second grayscale level and a second voltage corresponding to the second grayscale level to represent a black-scene on liquid crystal display panel during a second voltage-control which is just behind and in the same polarity as the first voltage-control.

28. A method for driving liquid crystal display in a multi-frame polarity inversion manner according to claim 27, wherein the first grayscale level can overdrive liquid crystal display panel.

29. A method for driving liquid crystal display in a multi-frame polarity inversion manner according to claim 27, further comprises a step of: setting a charging voltage compensation for brightness uniformity according to brightness distribution on liquid crystal display panel, wherein the charging voltage compensation is to divide liquid crystal display panel by plurality of compensation area which has a or plurality of compensation grayscale level to record necessary compensation for local brightness differential.

30. A method for driving liquid crystal display in a multi-frame polarity inversion manner according to claim 29, wherein the compensation grayscale level in every compensation area are arranged as step change.

31. A method for driving liquid crystal display in a multi-frame polarity inversion manner according to claim 29, wherein the compensation grayscale level in every compensation area are stored in a or plurality of look-up tables for downloading.

32. A method for driving liquid crystal display in a multi-frame polarity inversion manner according to claim 29, wherein the compensation area are defined by rectangular ranges.

33. A method for driving liquid crystal display in a multi-frame polarity inversion manner according to claim 29, wherein the compensation area are defined by linear ranges.

34. A method for driving liquid crystal display in a multi-frame polarity inversion manner according to claim 29, wherein the compensation grayscale level are detected by actual brightness distribution on liquid crystal display panel.

35. A method for driving liquid crystal display in a multi-frame polarity inversion manner according to claim 27, wherein the liquid crystal display panel is liquid crystal display (LCD), organic light emitting diode (OLED), or plasma display panel (PDP).

36. A method for driving liquid crystal display in a multi-frame polarity inversion manner comprises the following steps of:
setting two or more voltage-controls during frame period of liquid crystal display panel to increase frame rate;
setting a first grayscale level and a first voltage corresponding to the first grayscale level to represent brightness according to a target code of the frame period on liquid crystal display panel during a first voltage-control; and
setting a second grayscale level and a second voltage corresponding to the second grayscale level to represent brightness according to an overdrive code (OD code) of the frame period on liquid crystal display panel during a second voltage-control which is just behind and in the same polarity as the first voltage-control.

37. A method for driving liquid crystal display in a multi-frame polarity inversion manner according to claim 36 also comprises the following steps of:
setting a third voltage-control and a forth voltage-control or more voltage-controls during a next frame period behind the frame period of liquid crystal display panel to increase frame rate;
setting a third grayscale level and a third voltage corresponding to the third grayscale level to represent brightness on liquid crystal display panel during the third voltage-control; and
setting a forth grayscale level and a forth voltage corresponding to the forth grayscale level to represent brightness on liquid crystal display panel during the forth voltage-control which is just behind and in the same polarity as the third voltage-control, wherein the third voltage and the forth voltage are in the same polarity which is opposite with the polarity of first and second voltage-controls.

38. A method for driving liquid crystal display in a multi-frame polarity inversion manner according to claim 37, wherein the third grayscale level is a target code of the frame period.

39. A method for driving liquid crystal display in a multi-frame polarity inversion manner according to claim 37, wherein the forth grayscale level is a feedback OD code adjusted by the second grayscale level during the second voltage-control to overdrive LCD panel.
